(19) United States
(12) Patent Application Publication
(10) Pub. No.: US 2014/0274063 A1
(43) Pub. Date: Sep. 18, 2014

(54) SYSTEM AND METHOD FOR MITIGATING PING-PONG HANDOVERS AND CELL RESELECTIONS

(71) Applicant: QUALCOMM Incorporated, San Diego, CA (US)

(72) Inventors: Damanjit SINGH, San Diego, CA (US); Rajat PRAKASH, San Diego, CA (US); Mehmet YAVUZ, San Diego, CA (US)

(73) Assignee: QUALCOMM Incorporated, San Diego, CA (US)

(21) Appl. No.: 14/139,565

(22) Filed: Dec. 23, 2013

Related U.S. Application Data
(60) Provisional application No. 61/790,654, filed on Mar. 15, 2013.

(51) Int. Cl. H04W 36/36

(52) U.S. Cl. CPC H04W 36/36
USPC 455/437

(57) ABSTRACT

Disclosed are system and method for mitigating ping-pong handovers and cell reselections. In one aspect, the system and method are configured detect a plurality of cell changes by a mobile device, determine occurrence of at least one cell more than once in the detected plurality of cell changes, and apply one or more scaling factors to one or more parameters related to cell changes based on the determination.

### CLAIM OF PRIORITY UNDER 35 U.S.C. §119

The present application for patent claims priority to Provisional Application No. 61/790,654 filed on Mar. 15, 2013, and assigned to the assignee hereof and hereby expressly incorporated by reference herein.

### BACKGROUND

Wireless communication systems are widely deployed to provide using radio signals various types of content, such as voice, data, and video, to mobile devices. Typical wireless communication systems may be multiple-access systems capable of supporting communication with multiple mobile devices by sharing available system resources (e.g., bandwidth, transmit power, etc.). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), evolution data optimized (EV-DO), etc.

Generally, wireless multiple-access communication systems may simultaneously support communication for multiple mobile devices. Each mobile device may communicate with one or more base stations (e.g., which can be commonly referred as macrocells). To supplement conventional base stations (e.g., macrocells), additional low power base stations (e.g., which can be commonly referred as small cells, femtocells or picocells) can be deployed to provide more robust wireless coverage to mobile devices. For example, low power base stations can be deployed for incremental capacity growth, richer user experience, in-building or other specific geographic coverage, and/or the like. Generally, these low power base stations are often deployed in homes, offices, etc. without consideration of the existing network infrastructure.

In a small cell or mixed macrocell deployment, frequent cell changes may occur in the pilot pollution regions between neighboring cells when, for example, a mobile device detects two or more strong pilot signals from the neighboring cells and begins to change its connection back and forth between these cells due to temporal fluctuations in the pilot signals strengths from those cells. These cell changes could be either in the form of handovers or cell reselections. For example, a mobile device in a connected-mode state may perform handovers between neighboring cells, while a mobile device in an idle-mode state may perform cell reselections between neighboring cells. Moreover, frequent cell changes between neighboring cells, where cell changes involve the same set of cells, can be referred to as ping-pong cell changes. Frequent ping-pong handovers and cell reselections are not desired in a wireless system as they can result in increased signaling load in the network and impact user experience. For example, frequent cell reselections can result in frequent mobile device registrations on different cells, which in return would impact user experience due to increased battery drainage of the mobile device and possible missing of pages at the mobile device. As another example, frequency handovers can impact user experience due to data interruptions and packet losses or delays. Therefore, it is desired to mitigate frequent ping-pong handovers and cell reselections by mobile devices between neighboring cells.

### SUMMARY

The following presents a simplified summary of one or more aspects of mechanisms for mitigating frequent ping-pong cell changes, including frequent ping-pong handovers and frequent ping-pong cell reselections between neighboring cells. This summary is not an extensive overview of all contemplated aspects of the invention, and is intended to neither identify key or critical elements of the invention nor delineate the scope of any or all aspects thereof. Its sole purpose is to present some concepts of one or more aspects in a simplified form as a prelude to the more detailed description that is presented later.

In one example aspect, a system for mitigating frequent ping-pong handovers and frequent ping-pong cell reselections between neighboring cells includes a frequent cell change detection component configured to detect a plurality of cell changes by a mobile device and to determine occurrence of at least one cell more than once in the detected plurality of cell changes. The system further includes a parameter adjustment component configured to apply one or more scaling factors to one or more parameters related to cell changes based on the determination of occurrence of at least one cell more than once in the detected plurality of cell changes.

In one aspect, the plurality of cell changes include handovers and cell reselections, which in turn include frequent handovers and frequent cell reselections.

In another aspect, the plurality of cell changes occurs between neighboring radio network cells.

In another aspect, detecting a plurality of cell changes by a mobile device includes detecting cell changes within a time duration.

In another aspect, one or more parameters include at least one of a time to trigger parameter, Treselection, Qhyst, a3-offset, and cell individual offset.

In another aspect, one or more scaling factors include scaling factor greater than or equal to one.

In another aspect, one or more scaling factors include scaling factor greater than or equal to zero.

In another aspect, applying one or more scaling factors include at least one of multiplying or adding operation.

In another aspect, one or more parameters include parameters related to at least one of cell reselections or handovers.

In another aspect, a method for wireless communication includes detecting a plurality of cell changes by a mobile device, determining occurrence of at least one cell more than once in the detected plurality of cell changes, and applying one or more scaling factors to one or more parameters related to cell changes based on the determination.

In another aspect, an apparatus for wireless communication includes means for detecting a plurality of cell changes by a mobile device, means for determining occurrence of at least one cell more than once in the detected plurality of cell changes, and means for applying one or more scaling factors to one or more parameters related to cell changes based on the determination.

In another aspect, a computer program product wireless communication includes a non-transitory computer-readable medium comprising: code for detecting a plurality of cell changes by a mobile device, code for determining occurrence of at least one cell more than once in the detected plurality of cell changes, and code for applying one or more scaling factors to one or more parameters related to cell changes based on the determination.

In another aspect, a method for wireless communication includes detecting a plurality of cell changes by a mobile device, determining occurrence of at least one cell more than once in the detected plurality of cell changes, and changing one or more parameters related to cell changes based on the determination.

In another aspect, an apparatus for wireless communication includes a frequent cell change detection component configured to detect a plurality of cell changes by a mobile device and determine occurrence of at least one cell more than once in the detected plurality of cell changes; and a parameter adjustment component configured to change one or more parameters related to cell changes based on the determination.

In another aspect, an apparatus for wireless communication include means for detecting a plurality of cell changes by a mobile device, means for determining occurrence of at least one cell more than once in the detected plurality of cell changes, and means for changing one or more parameters related to cell changes based on the determination.

In another aspect, a computer program product for wireless communication includes a non-transitory computer-readable medium comprising code for detecting a plurality of cell changes by a mobile device, code for determining occurrence of at least one cell more than once in the detected plurality of cell changes, and code for changing one or more parameters related to cell changes based on the determination.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram illustrating an example wireless communication system in which frequent ping-pong handovers and frequent ping-pong cell reselections by mobile devices between neighboring cells can be observed.

FIG. 2 is a block diagram illustrating an example system for mitigating frequent ping-pong handovers and frequent ping-pong cell reselections according to one aspect.

FIG. 3 is a flow diagram illustrating one example methodology for mitigating frequent ping-pong handovers and frequent ping-pong cell reselections according to one aspect.

FIGS. 4A, 4B and 4C are flow diagrams illustrating example methodologies for mitigating frequent ping-pong handovers and frequent ping-pong cell reselections according to other aspect.

FIGS. 5A and 5B are block diagrams illustrating example systems for mitigating frequent ping-pong handovers and frequent ping-pong cell reselections according to one aspect.

FIG. 6 is a block diagram of an example wireless communication system in accordance with various aspects set forth herein.

FIG. 7 is an illustration of an example wireless network environment that can be employed in conjunction with the various systems and methods described herein.

FIG. 8 is an illustration of an exemplary communication system to enable deployment of small cells within a network environment.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

In various aspects, disclosed herein systems and methods for dynamic power regulation of small cells. A small cell may also be referred to as a low power base station (BS), an access point, a femto node, a pico node, a micro node, a Node B, evolved Node B (eNB), home Node B (HNB) or home evolved Node B (HeNB), collectively referred to as H(e)NB, or some other terminology. The term “small cell,” as used herein, refers to a relative low transmit power and/or a relatively small coverage area cell as compared to a transmit power and/or a coverage area of a macrocell. For area cell as compared to a transmit power and/or a coverage area of a macrocell. For instance, a macrocell may cover a relatively large geographic area, such as, but not limited to, several kilometers in radius. In contrast, a small cell may cover a relatively small geographic area, such as, but not limited to, a home, or a floor of a building.

Macrocells and small cells may be utilized for communicating with mobile devices. As generally known in the art, a mobile device can also be called a system, device, subscriber unit, subscriber station, mobile station, mobile, remote station, mobile terminal, remote terminal, access terminal, user terminal, terminal, communication device, user agent, user device, or user equipment (UE). A mobile device may be a cellular telephone, a satellite phone, a cordless telephone, a Session Initiation Protocol (SIP) phone, a wireless local loop (WLL) station, a personal digital assistant (PDA), a handheld device having wireless connection capability, a tablet, a computing device, or other processing devices connected via a wireless modem to one or more BS that provide cellular or wireless network access to the mobile device.

The techniques described herein may be used for various wireless communication systems such as CDMA, TDMA, FDMA, OFDMA, SC-FDMA, WiFi carrier sense multiple access (CSMA), and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses. E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

FIG. 1 shows an example wireless communication system 100. System 100 includes one or more high-power base stations 102 (also referred as macro nodes) that can provide mobile devices 105 with access to a wireless network, which is depicted as a mobile operator core network 110 (also referred as backhaul network), which provides telecommunication services, such as voice, data, video, etc. to mobile devices 105. The coverage area of a macro node 102 is referred to as a macrocell 112. The system 100 also includes a plurality of low-power base stations 104 and 106 (also commonly referred to herein as low-power nodes), which expand the coverage and increase the capacity of the wireless network. The coverage area of the low power nodes 104 and 106 is referred to herein as small cells 114 and 116, respectively.

In the depicted wireless network deployment, a mobile device 105 may go through frequent ping-pong handovers and frequent ping-pong cell reselections when, for example, it travels at the edge of neighboring small cells (e.g., small cells 114 and 116). Additionally, even a stationary or slow moving mobile device 105 can experience frequent ping-pong handovers and frequent ping-pong cell reselections due to channel fading if it is present at a location where pilot signals from neighboring low power nodes (e.g., low power base stations 104 and 106) are about the same strength. This location is typically referred to as a pilot pollution region. These frequent ping-pong handovers and frequent ping-pong cell reselections between neighboring small cells are undesirable as they can cause packet losses, leading to voice artifacts and/or packet delays and/or poor user experience, as well as increase signaling load at the neighboring low power nodes (e.g., low power nodes 104 and 106) and/or core network 110.

FIG. 2 illustrates one example implementation of a system for mitigating frequent ping-pong handovers and frequent ping-pong cell reselections by mobile devices. In one aspect, the system 200 includes a cell controller 202, which can be implemented in a low power node, such as base stations 104 and 106 of FIG. 1. In another aspect, the cell controller 202, including one or more components thereof, may be implemented in a separate processing device in a mobile operator core network 110. In another aspect, the system 200 also includes a mobile device controller 210, which can be implemented in a mobile device, such as mobile device 105 of FIG. 1.

In one aspect, the cell controller 202 may include at least one of the following components: a ping-pong handovers mitigation component 206 and a ping-pong cell reselection mitigation component 208. For example, frequent ping-pong cell reselections may occur when the mobile device 105 performs multiple attempts (e.g., two or more) to register and/or deregister with two or more neighboring small cells or macrocells within a short period of time (e.g. 10 minutes or less). Frequent ping-pong handover may occur when the mobile device 105 actually transfers back and forth multiple times (e.g., two or more) an ongoing call or data session between two or more neighboring cells within a short period of time (e.g. 10 minutes or less).

In one aspect, a ping-pong handovers mitigation component 206 may be configured to provide to the mobile device 105 with one or more handover scaling factors. In one aspect, the handover scaling factors may be used by the mobile device 105 to adjust (e.g., scale up) one or more handover parameters of the mobile device 105 in order to mitigate (e.g., reduce) the number of frequent ping-pong handovers by the mobile device 105 between neighboring radio network cells. In one aspect, the handover parameter may include a time to trigger (TIT) parameter, which controls the time interval for which the mobile device 105 evaluates an event criteria before the mobile terminal triggers a report for that event. For example, after detecting a better neighbor cell, mobile device 105 may wait for at least the duration specified by time to trigger parameter before reporting an event (e.g., Event A3, Event 1d, Event 1a) that informs the network of the availability of the better neighbor cell and hence, allows initiation of handover from the serving cell to the better neighbor cell. Therefore, to reduce the number of frequent ping-pong handovers between neighboring cells, the ping-pong handovers mitigation component 206 may provide to the mobile device 105 a TTT scaling factor that can scale up (increase) the value of the TTT parameter of the mobile device 105. In one aspect, the value of the TTT scaling factor may be greater than or equal to one. The mobile device 105 can multiply its received TTT parameter with the received TTT scaling factor in order to increase its evaluation time for handovers, which, consequently, can reduce the number of ping-pong handovers. For example, if ping-pong handovers are due to temporary fluctuations in radio environment, then increase in evaluation time by using TTT scaling factor can help to avoid unnecessary handovers. However, if the ping-pong handovers are due to significant change in radio environment, then increase in evaluation time by using TTT scaling factor may only delay but not avoid handovers.

In another aspect, the handover parameter may include an offset parameter (e.g., a3-Offset, cell individual offset), which controls the amount by which a neighboring cell has to be stronger or weaker than the current serving cell for the mobile device 105 to trigger a report.

In yet another aspect, the handover parameter may include an hysteresis parameter, which controls the entry and leave condition of an event (e.g., Event A3) at the mobile device 105.

In other aspects, different or additional handover parameters and scaling factors known to those of ordinary skill in the art may be used to mitigate the number of frequent ping-pong handovers by the mobile device 105.

In one aspect, a ping-pong cell reselection mitigation component 208 may be configured to provide to the mobile device 105 with one or more cell reselection scaling factors. In one aspect, the cell reselection scaling factors may be used by the mobile device 105 to adjust (e.g., scale up) one or more cell reselection parameters of the mobile device 105 in order to mitigate (e.g., reduce) the number of frequent ping-pong cell reselections by the mobile device 105 between neighboring radio network cells. In one aspect, the cell reselection parameter may include a Treselection parameter, which specifies the cell reselection timer value used by the mobile device 105 to determine when to attempt a cell reselection after serving cell is no longer the best cell. Therefore, to reduce the number of frequent ping-pong cell reselections between these cells, the ping-pong cell reselection mitigation component 208 may provide to the mobile device 105 a Treselection scaling factor that can scale up (increase) the value of the Treselection parameter of the mobile device 105. In one aspect, the value of the Treselection scaling factor may be greater than or equal to one. The mobile device 105 can multiply its internal Treselection parameter with the received Treselection scaling factor in order to reduce the number of ping-pong cell reselections. In another aspect, the cell reselection parameter may include a Qhyst parameter, which specifies the hysteresis value for evaluating the ranking criteria for cell reselections. Therefore, to reduce the number of frequent ping-pong cell reselections between these cells, the ping-pong cell reselection mitigation component 208 may provide to the mobile device 105 a Qhyst scaling factor that can scale up (increase) the value of the Qhyst parameter of the mobile device 105. In one aspect, the value of the Qhyst scaling factor may be greater than or equal to zero. The mobile device 105 can add Qhyst scaling factor to its internal Qhyst parameter in order to reduce the number of ping-pong cell reselections. In other aspect, different or additional cell reselection parameters, such as Qoffset (which specifies an offset between the serving and the neighboring cell), Qqualmin (which specifies minimum required quality level in the cell in dB), and other, as well as corresponding scaling factors may be used to mitigate the number of ping-pong cell reselections by the mobile device 105.

In one aspect, the mobile device controller 210 of system 200 may include a frequent cell change detection component 212, a scaling factor requesting component 214 and a parameter adjustment component 216 that enable mobile device 105 to mitigate frequent ping-pong handovers and frequent ping-pong cell reselections with assistance of the cell controller 202.

In one aspect, the frequent cell change detection component 212 may be configured to determine whether the mobile device undergoes frequent ping-pong handovers and/or frequent ping-pong cell reselections between neighboring radio network cells, such as macrocell 112 and/or small cells 114 and/or 116. In one example, the component 212 may detect frequent ping-pong cell reselections when the mobile device 105 selects/reselects to one of the small cells or macrocells more than once (e.g., 3 times) within a short period of time (e.g. 15 seconds). Similarly, frequent ping-pong handover may be detected when ongoing call or data session of the mobile device 105 is handed over to at least one cell more than once (e.g., 3 times) within a short period of time (e.g. 15 seconds). These time periods may be selected based on results of simulation, system requirements, or real-time data.

In another aspect, having identified that the mobile device 105 undergoes frequent ping-pong handovers and/or frequent ping-pong cell reselections, the scaling factor requesting component 214 may request cell controller 202 to provide one or more handover and/or cell reselection scaling factors, such as TTT scaling factor, Treselection scaling factor, Qhyst scaling factor or other. Having obtained the one or more scaling factors, the parameter adjustment component 216 of the mobile device 105 may apply the received scaling factors to the corresponding handover and cell reselection parameters in order to decrease the number of frequent ping-pong handovers and/or frequent ping-pong cell reselections. For example, the component 216 may multiply TTT parameter by the received TTT scaling factor. In another example, the component 216 may multiply Treselection parameter by the received Treselection scaling factor. In yet another example, the component 216 may add Qhyst scaling factor to the Qhyst parameter. Similar operation may be performed with other handover parameters and cell reselection parameters and their corresponding scaling factors.

FIGS. 3 and 4A, 4B and 4C illustrate example methodologies for mitigating frequent ping-pong handovers and frequent ping-pong cell reselections by mobile devices based on the principles disclosed herein. Methodologies 300, 40, 45 and 400 may be implemented by the mobile device controller 210 of FIG. 2. While, for purposes of simplicity of explanation, the methodology is shown and described as a series of acts, it is to be understood and appreciated that the methodology is not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Turning to FIG. 3, at step 305, the method 300 includes detecting one or more cell changes by a mobile device between neighboring network cells, where at least one cell occurs more than once in the detected cell changes. For example, in one aspect, the mobile device controller 210 may include a frequent cell change detection component 212 that may be configured to detect one or more of frequent ping-pong handovers and frequent ping-pong cell reselections by the mobile device. At step 310 if the detected cell changes are frequent handovers, then at step 315, the method 300 includes using the one or more scaling factors, such as TTT scaling factor, at the mobile device to scale up one or more handover parameters, such as TTT. In one aspect, the cell controller 200 may include a ping-pong handover mitigation component 206 that may be configured to provide to the mobile device one or more handover scaling factors, such as TTT scaling factors. At step 320, if the detected cell changes are frequent ping-pong cell reselections, then at step 325, the method 300 includes using the scaling factors, such as Treselection scaling factor, at the mobile device to scale up one or more cell reselection parameters, such as Treselection. It should be noted, that in one example aspect, the scaling factors may be provided at the start of the call or when the mobile device is in idle-mode, where it does not have any radio connection with the wireless network, and may not necessarily be provided when frequent ping pong handovers and cell reselections are detected. In one aspect, the cell controller 200 may include a ping-pong cell reselection mitigation component 208 that may be configured to provide to the mobile device one or more cell reselection scaling factors, such as Treselection and Qhyst scaling factors.

Turning to FIG. 4A at step 41, the method 40 includes detecting plurality of cell changes by a mobile device. At step 42, the method 40 includes determining occurrence of at least one cell more than once in the detected plurality of cell changes. For example, in one aspect, a frequent cell change detection component 212 of mobile device controller 210 is configured to detect a plurality of cell changes by a mobile device and determine occurrence of at least one cell more than once in the detected plurality of cell changes. At step 43, the method 40 further includes applying one or more scaling factors to one or more parameters related to cell changes based on the determination. In one aspect, a parameter adjustment component 216 of mobile device controller 210 is configured to apply one or more scaling factors to one or more parameters related to cell changes based on the determination.

Turning to FIG. 4B, at step 46, the method 45 includes detecting plurality of cell changes by a mobile device. At step 47, the method 45 includes determining occurrence of at least one cell more than once in the detected plurality of cell changes. For example, in one aspect, a frequent cell change detection component 212 of mobile device controller 210 is configured to detect a plurality of cell changes by a mobile device and determine occurrence of at least one cell more than once in the detected plurality of cell changes. At step 48, the method 45 includes changing one or more parameters related to cell changes based on the determination. In one aspect, a parameter adjustment component 216 of mobile device controller 210 is configured to change one or more parameters related to cell changes based on the determination.

Turning to FIG. 4C, at step 405, the method 400 includes detecting one or more of frequent ping-pong handovers and frequent ping-pong cell reselections by a mobile device between neighboring radio network cells. For example, in one aspect, the mobile device controller 210 may include a frequent cell change detection component 212 that may be configured to detect one or more of frequent ping-pong handovers and frequent ping-pong cell reselections by the mobile device. At step 410, the method 400 includes obtaining from the network one or more handover scaling factors that can be used to scale up one or more handover parameters of the mobile device. In one aspect, the mobile device controller 210 may include a scaling factor requesting component 214 that may be configured request from the cell controller 202 one or more handover scaling factors, such as TTT scaling factor, and one or more cell reselection scaling factors, such as Treselection and Qhyst scaling factors. At steps 415 and 420, the method 400 includes adjusting one or more handover parameters and cell reselection parameters using obtained scaling factors. In one aspect, the mobile device controller 210 may include a parameter adjustment component 216 that may be configured to scale up one or more handover parameters and cell reselection parameters using appropriate scaling factors, such as TTT, Treselection and Qhyst scaling factors.

FIG. 5A illustrates a system 500 for mitigating frequent ping-pong handovers and frequent ping-pong cell reselections by mobile devices based on the principles disclosed herein. For example, system 500 can be implemented in cell controller 202 of FIG. 2, which resides within a low power node, such as a low power base stations 104 or 106 of FIG. 1. It is to be appreciated that system 500 is represented as including functional blocks, which can be functional blocks that represent functions implemented by a processor, software, or combination thereof (e.g., firmware). System 500 includes a logical grouping 502 of electrical components that can act in conjunction. For instance, logical grouping 502 can include an electrical component 505 for providing handover scaling factors to the mobile device. Further, logical grouping 502 can include an electrical component 506 for providing cell reselection scaling factors to the mobile device.

Additionally, system 500 can include a memory 508 that retains instructions for executing functions associated with the electrical components 505-506. While shown as being external to memory 508, it is to be understood that one or more of the electrical components 505-506 can exist within memory 508. In one example, electrical components 505-506 can comprise at least one processor, or each electrical component 505-506 can be a corresponding module of at least one processor. Moreover, in an additional or alternative example, electrical components 505-506 can be a computer program product comprising a computer readable medium, where each electrical component 505-506 can be corresponding code.

FIG. 5B illustrates a system 550 for mitigating frequent ping-pong handovers and frequent ping-pong cell reselections by mobile devices based on the principles disclosed herein. For example, system 550 can be implemented in mobile device controller 210 of FIG. 2, which resides within a mobile device, such as a mobile device 105 of FIG. 1. It is to be appreciated that system 550 is represented as including functional blocks, which can be functional blocks that represent functions implemented by a processor, software, or combination thereof (e.g., firmware). System 550 includes a logical grouping 552 of electrical components that can act in conjunction. For instance, logical grouping 552 can include an electrical component 554 for detecting frequent cell changes by the mobile device. Further, logical grouping 552 can comprise an electrical component 555 for obtaining handover scaling factors and cell reselection scaling factors from the network. Further, logical grouping 552 can include an electrical component 556 for adjusting handover parameters and cell reselection parameters.

Additionally, system 550 can include a memory 558 that retains instructions for executing functions associated with the electrical components 554-556. While shown as being external to memory 508, it is to be understood that one or more of the electrical components 554-556 can exist within memory 558. In one example, electrical components 554-556 can comprise at least one processor, or each electrical component 554-556 can be a corresponding module of at least one processor. Moreover, in an additional or alternative example, electrical components 554-556 can be a computer program product comprising a computer readable medium, where each electrical component 554-556 can be corresponding code.

Referring now to FIG. 6, a wireless communication system 600 in which mechanisms for mitigating frequent ping-pong handovers and frequent ping-pong cell reselections by mobile devices may be implemented. System 600 comprises a base station 602, which may be a low power node, such as low power base stations 104 or 106 of FIG. 1, and may include the components and implement the functions described above with respect to FIGS. 1-5. In one aspect, base station 602 can include multiple antenna groups. For example, one antenna group can include antennas 604 and 606, another group can comprise antennas 608 and 610, and an additional group can include antennas 612 and 614. Two antennas are illustrated for each antenna group; however, more or fewer antennas can be utilized for each group. Base station 602 can additionally include a transmitter chain and a receiver chain, each of which can in turn comprise a plurality of components associated with signal transmission and reception (e.g., processors, modulators, multiplexers, demodulators, demultiplexers, antennas, etc.), as is appreciated.

Base station 602 can communicate with one or more mobile devices such as mobile device 616 and mobile device 622, such as a mobile device 105 of FIG. 1; however, it is to be appreciated that base station 602 can communicate with substantially any number of mobile devices similar to mobile devices 616 and 622. Mobile devices 616 and 622 can be, for example, cellular phones, smart phones, laptops, handheld communication devices, handheld computing devices, satellite radios, global positioning systems, PDAs, and/or any other suitable device for communicating over wireless communication system 600. As depicted, mobile device 616 is in communication with antennas 612 and 614, where antennas 612 and 614 transmit information to mobile device 616 over a forward link 618 and receive information from mobile device 616 over a reverse link 620. Moreover, mobile device 622 is in communication with antennas 604 and 606, where antennas 604 and 606 transmit information to mobile device 622 over a forward link 624 and receive information from mobile device 622 over a reverse link 626. In a frequency division duplex (FDD) system, forward link 618 can utilize a different frequency band than that used by reverse link 620, and forward link 624 can employ a different frequency band than that employed by reverse link 626, for example. Further, in a time division duplex (TDD) system, forward link 618 and reverse link 620 can utilize a common frequency band and forward link 624 and reverse link 626 can utilize a common frequency band.

Each group of antennas and/or the area in which they are designated to communicate can be referred to as a sector of base station 602. For example, antenna groups can be designed to communicate to mobile devices in a sector of the areas covered by base station 602. In communication over forward links 618 and 624, the transmitting antennas of base station 602 can utilize beamforming to improve signal-to-noise ratio of forward links 618 and 624 for mobile devices 616 and 622. Also, while base station 602 utilizes beamforming to transmit to mobile devices 616 and 622 scattered randomly through an associated coverage, mobile devices in neighboring cells can be subject to less interference as compared to a base station transmitting through a single antenna to all its mobile devices. Moreover, mobile devices 616 and 622 can communicate directly with one another using a peer-to-peer or ad hoc technology as depicted. According to an example, system 600 can be a multiple-input multiple-output (MIMO) communication system.

FIG. 7 shows an example wireless communication system 700 in which mechanisms for mitigating frequent ping-pong handovers and frequent ping-pong cell reselections by mobile devices may be implemented. The wireless communication system 700 depicts one base station 710, which can include a low power node, such as a low power base station 104 of FIG. 1, and one mobile device 750 for sake of brevity, as such as mobile device 105 of FIG. 1. However, it is to be appreciated that system 700 can include more than one base station and/or more than one mobile device, wherein additional base stations and/or mobile devices can be substantially similar or different from example base station 710 and mobile device 750 described below. In addition, it is to be appreciated that base station 710 and/or mobile device 750 can employ the systems (FIGS. 1, 2, 5, and 6) and/or methods (FIGS. 3 and 4) described herein to facilitate wireless communication there between. For example, components or functions of the systems and/or methods described herein can be part of a memory 732 and/or 772 or processors 730 and/or 770 described below, and/or can be executed by processors 730 and/or 770 to perform the disclosed functions.

At base station 710, traffic data for a number of data streams is provided from a data source 712 to a transmit (TX) data processor 714. According to an example, each data stream can be transmitted over a respective antenna. TX data processor 714 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 750 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 730.

The modulation symbols for the data streams can be provided to a TX MIMO processor 720, which can further process the modulation symbols (e.g., for OFDM). TX MIMO processor 720 then provides N_{T} modulation symbol streams to N_{T} transmitters (TMTR) 722a through 722t. In various embodiments, TX MIMO processor 720 applies beamforming weights to the symbols of the data streams and to the antenna from which the symbol is being transmitted.

Each transmitter 722 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 722a through 722t are transmitted from N_{T} antennas 724a through 724t, respectively.

At mobile device 750, the transmitted modulated signals are received by N_{R} antennas 752a through 752r and the received signal from each antenna 752 is provided to a respective receiver (RCVR) 754a through 754r. Each receiver 754 conditions (e.g., filters, amplifies, and downconverts) a respective signal, digitizes the conditioned signal to provide samples, and further processes the samples to provide a corresponding “received” symbol stream.

An RX data processor 760 can receive and process the N_{R} received symbol streams from N_{R} receivers 754 based on a particular receiver processing technique to provide N_{T} “detected” symbol streams. RX data processor 760 can demodulate, deinterleave, and decode each detected symbol stream to recover the traffic data for the data stream. The processing by RX data processor 760 is complementary to that performed by TX MIMO processor 720 and TX data processor 714 at base station 710.

The reverse link message can comprise various types of information regarding the communication link and/or the received data stream. The reverse link message can be processed by a TX data processor 738, which also receives traffic data for a number of data streams from a data source 736, modulated by a modulator 780, conditioned by transmitters 754a through 754r, and transmitted back to base station 710.

At base station 710, the modulated signals from mobile device 750 are received by antennas 724, conditioned by receivers 722, demodulated by a demodulator 740, and processed by a RX data processor 742 to extract the reverse link message transmitted by mobile device 750. Further, processor 730 can process the extracted message to determine which precoding matrix to use for determining the beamforming weights.

Processors 730 and 770 can direct (e.g., control, coordinate, manage, etc.) operation at base station 710 and mobile device 750, respectively. Respective processors 730 and 770 can be associated with memory 732 and 772 that store program codes and data. Processors 730 and 770 can also perform functionalities described herein to support selecting a paging area identifier for one or more low power nodes.

FIG. 8 illustrates an exemplary communication system 900 where one or more low power base stations are deployed within a network environment. Specifically, the system 900 includes multiple low power base stations, such as femto nodes 910A and 910B (e.g., small cell or H(e)NB) installed in a relatively small scale network environment (e.g., in one or more user residences 930), which, in one aspect, may correspond to low power base stations 104 and 106 of FIG. 1, and which can implement a cell controller 202 of FIG. 2. Each femto node 910 can be coupled to a wide area network 940 (e.g., the Internet) and a mobile operator core network 950 via a digital subscriber line (DSL) router, a cable modem, a wireless link, or other connectivity means (not shown). As will be discussed below, each femto node 910 can be configured to serve associated mobile devices 920 (e.g., mobile device 920A) and, optionally, alien mobile devices 920 (e.g., mobile device 920B), which, in one aspect, may correspond to mobile device 105 of FIG. 1, and which can implement a mobile device controller 210 of FIG. 2. In other words, access to femto nodes 910 can be restricted such that a given mobile device 920 can be served by a set of designated (e.g., home) femto node(s) 910 but may not be served by any non-designated femto nodes 910 (e.g., a neighbor's femto node).

The owner of a femto node 910 can subscribe to mobile service, such as, for example, 3G mobile service, offered through the mobile operator core network 950. In another example, the femto node 910 can be operated by the mobile operator core network 950 to expand coverage of the wireless network. In addition, a mobile device 920 can be capable of operating both in macro environments and in smaller scale (e.g., residential) network environments. Thus, for example, depending on the current location of the mobile device 920, the mobile device 920 can be served by a macrocell access node 960 or by any one of a set of femto nodes 910 (e.g., the femto nodes 910A and 910B that reside within a corresponding user residence 930). For example, when a subscriber is outside his home, he is served by a standard macrocell access node (e.g., node 960) and when the subscriber is at home, he is served by a femto node (e.g., node 910A). Here, it should be appreciated that a femto node 910 can be backward compatible with existing mobile devices 920.

A femto node 910 can be deployed on a single frequency or, in the alternative, on multiple frequencies. Depending on the particular configuration, the single frequency or one or more of the multiple frequencies can overlap with one or more frequencies used by a macrocell access node (e.g., node 960). In some aspects, an mobile device 920 can be configured to connect to a preferred femto node (e.g., the home femto node of the mobile device 920) whenever such connectivity is possible. For example, whenever the mobile device 920 is within the user's residence 930, it can communicate with the home femto node 910.

In some aspects, if the mobile device 920 operates within the mobile operator core network 950 but is not residing on its most preferred network (e.g., as defined in a preferred roaming list), the mobile device 920 can continue to search for the most preferred network (e.g., femto node 910) using a Better System Reselection (BSR), which can involve a periodic scanning of available systems to determine whether better systems are currently available, and subsequent efforts to associate with such preferred systems. Using an acquisition table entry (e.g., in a preferred roaming list), in one example, the mobile device 920 can limit the search for specific band and channel. For example, the search for the most preferred system can be repeated periodically. Upon discovery of a preferred femto node, such as femto node 910, the mobile device 920 selects the femto node 910 for camping within its coverage area.

A femto node can be restricted in some aspects. For example, a given femto node can only provide certain services to certain mobile devices. In deployments with so-called restricted (or closed) association, a given mobile device can only be served by the macrocell mobile network and a defined set of femto nodes (e.g., the femto nodes 910 that reside within the corresponding user residence 930). In some implementations, a femto node can be restricted to not provide, for at least one mobile device, at least one of: signaling, data access, registration, paging, or service.

In some aspects, a restricted femto node (which can also be referred to as a Closed Subscriber Group H(e)NB) is one that provides service to a restricted provisioned set of mobile devices. This set can be temporarily or permanently extended as necessary. In some aspects, a Closed Subscriber Group (CSG) can be defined as the set of access nodes (e.g., femto nodes) that share a common access control list of mobile devices. A channel on which all femto nodes (or all restricted femto nodes) in a region operate can be referred to as a femto channel.

Various relationships can thus exist between a given femto node and a given mobile device. For example, from the perspective of a mobile device, an open femto node can refer to a femto node with no restricted association. A restricted femto node can refer to a femto node that is restricted in some manner (e.g., restricted for association and/or registration). A home femto node can refer to a femto node on which the mobile device is authorized to access and operate on. A guest femto node can refer to a femto node on which a mobile device is temporarily authorized to access or operate on. An alien femto node can refer to a femto node on which the mobile device is not authorized to access or operate on, except for perhaps emergency situations (e.g., 911 calls).

From a restricted femto node perspective, a home mobile device can refer to an mobile device that authorized to access the restricted femto node. A guest mobile device can refer to a mobile device with temporary access to the restricted femto node. An alien mobile device can refer to a mobile device that does not have permission to access the restricted femto node, except for perhaps emergency situations, for example, 911 calls (e.g., an access terminal that does not have the credentials or permission to register with the restricted femto node).

For convenience, the various functionalities of the communication system 900 of FIG. 9 are described herein in the context of a femto node. It should be appreciated, however, that a pico node can provide the same or similar functionality as a femto node, but for a larger coverage area. For example, a pico node can be restricted, a home pico node can be defined for a given mobile device, and so on.

A wireless multiple-access communication system can simultaneously support communication for multiple wireless mobile devices. As mentioned above, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out system, a MIMO system, or some other type of system.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

As used herein, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

1. A method for wireless communication, comprising:
detecting a plurality of cell changes by a mobile device;
determining occurrence of at least one cell more than once in the detected plurality of cell changes; and
applying one or more scaling factors to one or more parameters related to cell changes based on the determination.

2. The method of claim 1, wherein the plurality of cell changes include one or more of handovers and cell reselections.

3. The method of claim 2, wherein one or more of handovers and cell reselections include one or more of frequent handovers and frequent cell reselections.

4. The method of claim 1, wherein the plurality of cell changes occur between neighboring radio network cells.

5. The method of claim 1, wherein detecting includes detecting within a time duration.

6. The method of claim 1, wherein one or more parameters include at least one of a time to trigger parameter, Treselection, hysteresis, Qhyst, offset, a3-offset, and cell individual offset.

7. The method of claim 1, wherein one or more scaling factors include scaling factor greater than or equal to one.

8. The method of claim 1, wherein one or more scaling factors include scaling factor greater than or equal to zero.

9. The method of claim 1, wherein applying one or more scaling factors includes at least one of multiplying or adding operation.

10. The method of claim 1, wherein one or more parameters include parameters related to at least one of cell reselections or handovers.

11. An apparatus for wireless communication, comprising:
a frequent cell change detection component configured to detect a plurality of cell changes by a mobile device and determine occurrence of at least one cell more than once in the detected plurality of cell changes; and
a parameter adjustment component configured to apply one or more scaling factors to one or more parameters related to cell changes based on the determination.

12. The apparatus of claim 11, wherein the plurality of cell changes include one or more of handovers and cell reselections.

13. The apparatus of claim 12, wherein one or more of handovers and cell reselections include one or more of frequent handovers and frequent cell reselections.

14. The apparatus of claim 11, wherein the plurality of cell changes occur between neighboring radio network cells.

15. The apparatus of claim 11, wherein detecting includes detecting within a time duration.

16. The apparatus of claim 11, wherein one or more parameters include at least one of a time-to-trigger parameter, Treselection, hysteresis, Qhyst, offset, a3-offset, and cell individual offset.

17. The apparatus of claim 11, wherein one or more scaling factors include scaling factor greater than or equal to one.

18. The apparatus of claim 11, wherein one or more scaling factors include scaling factor greater than or equal to zero.

19. The apparatus of claim 11, wherein applying one or more scaling factors includes at least one of multiplying or adding operation.

20. The apparatus of claim 11, wherein one or more parameters include parameters related to at least one of cell reselections or handovers.

21. An apparatus for wireless communication, comprising:
means for detecting a plurality of cell changes by a mobile device;
means for determining occurrence of at least one cell more than once in the detected plurality of cell changes; and
means for applying one or more scaling factors to one or more parameters related to cell changes based on the determination.

22. The apparatus of claim 21, wherein the plurality of cell changes include one or more of frequent handovers and frequent cell reselections.

23. A computer program product wireless communication, the product comprising a non-transitory computer-readable medium comprising:
code for detecting a plurality of cell changes by a mobile device;
code for determining occurrence of at least one cell more than once in the detected plurality of cell changes; and
code for applying one or more scaling factors to one or more parameters related to cell changes based on the determination.

24. The computer program product of claim 23, wherein the plurality of cell changes include one or more of frequent handovers and frequent cell reselections.

25. A method for wireless communication, comprising:
detecting a plurality of cell changes by a mobile device;
determining occurrence of at least one cell more than once in the detected plurality of cell changes; and
changing one or more parameters related to cell changes based on the determination.

26. The method of claim 25, wherein the plurality of cell changes include one or more of frequent handovers and frequent cell reselections.

27. An apparatus for wireless communication, comprising:
a frequent cell change detection component configured to detect a plurality of cell changes by a mobile device and determine occurrence of at least one cell more than once in the detected plurality of cell changes; and
a parameter adjustment component configured to change one or more parameters related to cell changes based on the determination.

28. The apparatus of claim 27, wherein the plurality of cell changes include one or more of frequent handovers and frequent cell reselections.

29. An apparatus for wireless communication, comprising:
means for detecting a plurality of cell changes by a mobile device;
means for determining occurrence of at least one cell more than once in the detected plurality of cell changes; and
means for changing one or more parameters related to cell changes based on the determination.

30. The apparatus of claim 29, wherein the plurality of cell changes include one or more of frequent handovers and frequent cell reselections.

31. A computer program product for wireless communication, the product comprising a non-transitory computer-readable medium comprising:
code for detecting a plurality of cell changes by a mobile device;
code for determining occurrence of at least one cell more than once in the detected plurality of cell changes; and
code for changing one or more parameters related to cell changes based on the determination.

32. The computer program product of claim 31, wherein the plurality of cell changes include one or more of frequent handovers and frequent cell reselections.
